(19) United States
(12) Patent Application Publication
(10) Pub. No.: US 2002/0122616 A1
(43) Pub. Date: Sep. 5, 2002

(54) Optical beacon for aligning mirror systems

(76) Inventor: Donald Bruns, San Diego, CA (US)

Correspondence Address: EASTMAN & ASSOCIATES, Suite 306, 520 West Ash Street, San Diego, CA, 92101, US

(21) Appl. No.: 09/960,225

(22) Filed: Sep. 20, 2001

Related U.S. Application Data
(60) Provisional application No. 60/273,462, filed on Mar. 5, 2001.

(51) Int. Cl. G02B 6/35; G02B 5/00; G02B 6/26

(52) U.S. Cl. 385/16; 359/896

(57) ABSTRACT

A system and method for the alignment of optical elements using an unmounted LED die with a small lens as a beacon for each channel in an optical switch. One LED is mounted next to each optical fiber in an alignment hole in a ceramic form. Each LED has a conductive trace and wire bond for independent electrical control. The LED shines through a pinhole to limit the divergence of the beam. The pinhole is at the focus of a small lens which is positioned adjacent to the form, and creates a real image at its target. Because the LED and fiber are fixed closely together in the form, misalignment due to thermal effects or mechanical drift is negligible.

### RELATED APPLICATION

This application is a continuation in part of Provisional Application Serial No: 60/273,462 is entitled “Optical Beacon For Aligning Mirror Systems” filed Mar. 5, 2001.

### FIELD OF THE INVENTION

The present invention relates generally to optical network systems. More specifically, the present invention pertains to methods of aligning optical network components. The present invention is particularly, though not exclusively, useful for aligning mirrors—including but not limited to those in connection with micro-electromechanical switches (MEMS)—in multi-channel optical switches, using unmounted LED dice with small lenses.

### BACKGROUND OF THE INVENTION

Over the past several decades, the use of optical fibers, or fiber optics, to transmit information on a light beam have become increasingly popular. In fact, much of the information which is transmitted today is done over optical fibers. A difficulty of implementing an optical switch having a communication beam and an alignment beam, is that the alignment beam, or beacon, source for optical alignment must be low power, is preferably a different wavelength than the parallel communications beam, detectable with an inexpensive silicon detector, switchable on and off independent of other switches, and produce a nearly diffraction-less beam. Several alternative schemes have been considered. For example, a laser diode array produces a goodly amount of light, but it also produces too much heat because a lasing threshold must be reached. Another option is that a large beacon source can be used, but this does not allow individual channel control. However, a large source can be used with a modulator—for example, a liquid crystal—to make a usable device. Unfortunately, a liquid crystal modulator introduces undesirable features.

Accordingly, it is an object of the present invention to provide an optical beacon, for aligning optical elements, that meets the above requirements.

### SUMMARY OF THE PRESENT INVENTION

To satisfy the above requirements, the present invention utilizes an unmounted LED die with a small lens as a beacon for each channel in an optical switch. One LED is mounted next to each optical fiber which is inside an alignment hole on a rigid ceramic form. Each LED has a conductive trace and wire bond for independent electrical control. The LED shines through a pinhole to limit the divergence of the beam. The pinhole is at the focus of a small lens which is positioned adjacent to the form, and creates a real image at its target. Because the LED and fiber are fixed closely together in the form, misalignment due to thermal effects or mechanical drift is negligible.

### DESCRIPTION OF THE DRAWINGS

The novel features of this invention, as well as the invention itself, both as to its structure and its operation, will be best understood from the accompanying drawing, taken in conjunction with the accompanying description, in which like reference characters refer to similar parts, and in which:

FIG. 1 is a front view of a first preferred embodiment of the present invention showing a 16-channel array of fibers and LEDs in a ceramic form;

FIG. 2 is a front view of the first preferred embodiment of the present invention showing a lens panel superimposed on the array shown in FIG. 1, with the lens panel cutaway to show the array underneath; and

FIG. 3 is a cross-sectional view of the first preferred embodiment of the present invention taken along line 3—3 of FIG. 2, showing the relative placement and dimensions of the optical fiber, LED, pinhole in mask, and lens panel;

FIG. 4 is a cross-sectional view of a second preferred embodiment of the present invention taken along line 3—3 of FIG. 2, with the LED in back of the form, and the pinhole in the form.

### DETAILED DESCRIPTION

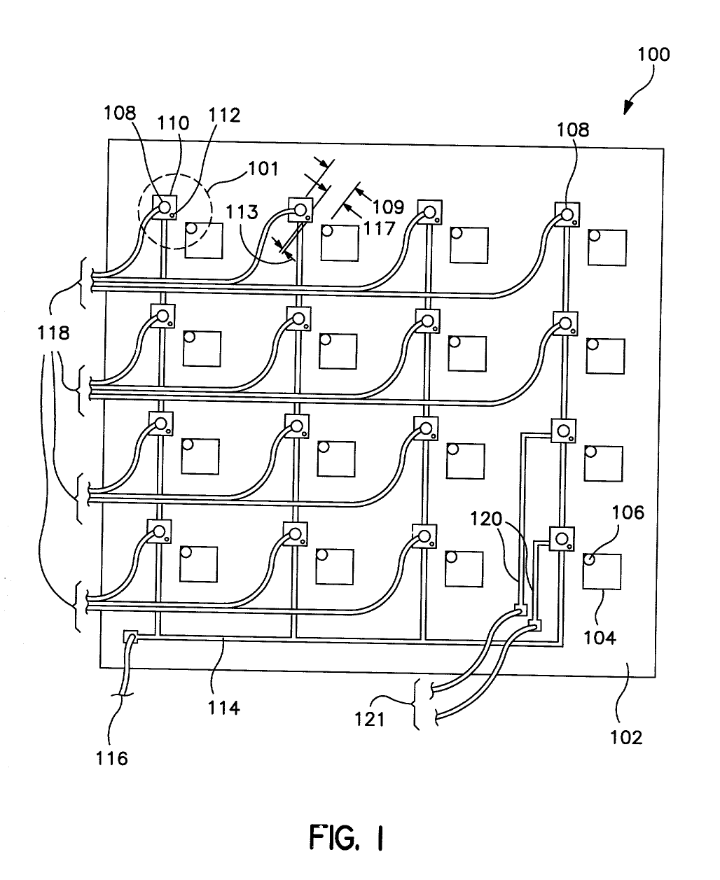

Referring initially to FIG. 1, a front view of a preferred embodiment of the Optical Beacon for Aligning Mirror Systems (“array”) of the present invention is shown and generally designated 100. In FIG. 1, array 100 is a 16-channel optical array. More precisely, array 100 is a 4-by-4 two-dimensional array of 16 optical channels 101 in a form 102. Form 102 is shown in FIG. 1 as a shallow parallelepiped. Alternative shapes for form 102 include but are not limited to prismatoid, pyramidal, tetrahedral, ovoid, lenticular, cylindrical, conic, etc. FIG. 1 shows surface 103 of form 102 as planar. Alternatives for surface 103 include but are not limited to convex, concave, sinusoidal, serrated, etc. Form 102 can be made of ceramic. Alternative materials for form 102 include but are not limited to glass, composite, plastic, etc.

Each channel 101 comprises a communication beam and a beacon beam. The communication beam comes from an optical element, such as an optical fiber for example, positioned at a known location in form 102. This location can be, for example, a corner of an alignment hole 104 in form 102. Please note that fibers 106 are not in themselves part of the present invention. However, fibers 106 are shown in FIG. 1 to illustrate how the present invention can be used to align such fibers with other optical elements. Holes 104 are shown in FIG. 1 as square. Alternative shapes for holes 104 include but are not limited to oval, trapezoidal, triangular, pentagonal, pentagramal, hexagramal, septagramal, etc. Another alternative is that the LEDs or fibers can be mounted on the surface of form 102, or in recesses in form 102.

LED 108 can be mounted on the front of form 102, and a mask 110 having a pinhole 112 can be placed over LED 108. In addition, LED 108 can be partially or wholly recessed in form 102. In any case, pinhole 112 is placed a predetermined distance 117 in a predetermined direction from the location of fiber 106 in hole 104. Pinhole 112 has a width 113. Pinhole 112 limits the divergence of light from LED 108. Pinholes 112 are shown in FIG. 1 as circular. Alternative shapes for pinholes 112 include, but are not limited to oval, trapezoidal, triangular, pentagonal, pentagramal, hexagramal, septagramal, etc.

Distance 109 and distance 117 are typically on the scale of 0.3 millimeter. This causes any thermal effects and mechanical drift to be common to LED 108, pinhole 112 and the location of fiber 106 in hole 104, which reduces misalignment problems to negligible levels.

Each LED 108 is in common electrical connection with a common conductive path 114 (electrical ground) on form 102. FIG. 1 shows common conductive path 114 as a conductive trace on form 102. Alternatively, common conductive path 114 can be wire. Common path 114 is connected to a connector 116 (ground wire). Each LED is uniquely bonded to a unique wire 118 which, in conjunction with common conductive path 114, provides for the independent switching on and off of each LED 108. Alternatively, each LED 108 may be provided with two conductive traces on form 102, one being common conductive path 114, and the other being a unique conductive path 120 to uniquely switch each LED 108 on and off. Each unique path 120 is uniquely connected to a unique connector 121.

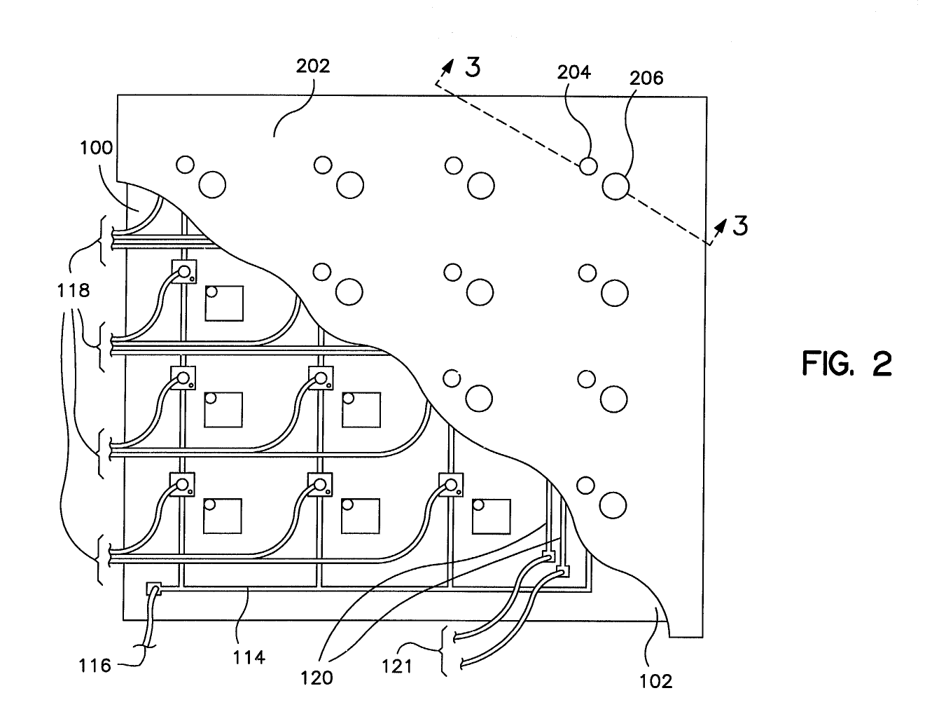

FIG. 2 shows the same front view of the first preferred embodiment of the present invention generally designated 100 as in FIG. 1, except that a lens panel 202 is superimposed on array 100 and partially cut away to show array 100 beneath panel 202. For each channel 101, panel 202 contains a beacon lens 204 facing its corresponding pinhole 112, and a communication lens facing its corresponding fiber 106.

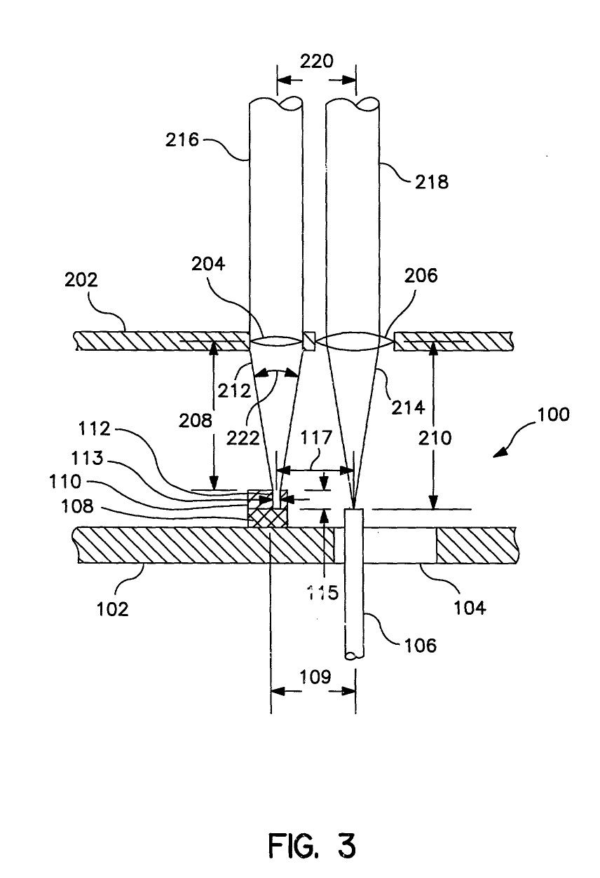

FIG. 3 is a cross-sectional view of the first preferred embodiment of the present invention as taken along line 3—3 of FIG. 2.

Each beacon lens 204 faces its corresponding pinhole 112 at a distance 208 from pinhole 112, which distance 208 is nearly equal to the focal length of beacon lens 204, so that beacon light 212 from pinhole 112 is nearly collimated by beacon lens 204 into beacon beam 216. Each communication lens 206 is similarly placed facing its corresponding fiber 106 at a distance 210 from fiber 106, which distance 210 is nearly equal to the focal length of communication lens 206, so that communication light 214 from fiber 106 is collimated by communication lens 206 into communication beam 218. Beacon beam 216 and communication beam 218 may or may not be parallel, depending on the configuration of their respective targets. Each beam forms a real image at its respective target by and equivalent lens pair on the receiving side.

In an alternative embodiment as shown in FIG. 3, pinhole 112 has a height 115 greater than its width 113. This is to limit the divergence of beacon light 212 exiting pinhole 112. Diameter 113 can be greater than height 115, but then beacon light 212 would diverge more, and collimating it would require that distance 208 be changed, or that beacon lens 204 be replaced with a lens having a different focal length, or both.

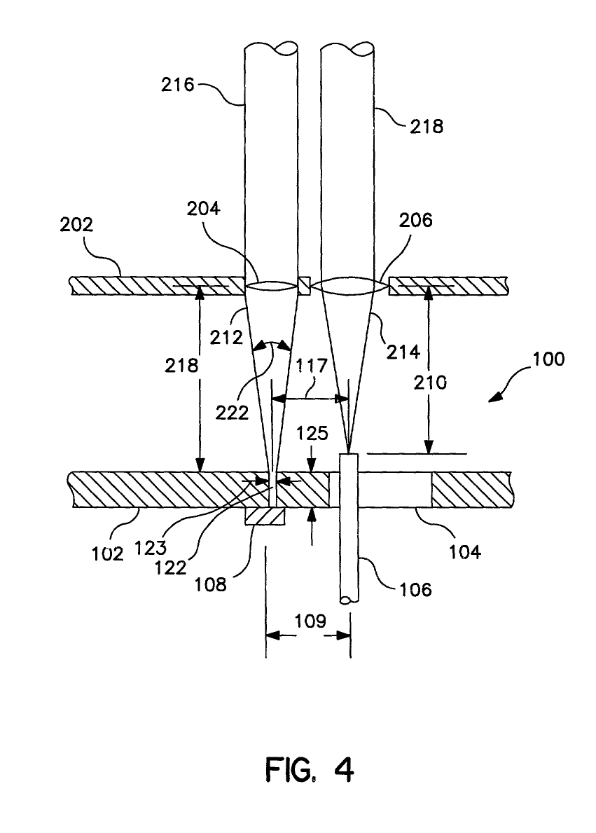

FIG. 4 is a cross-sectional view of a second preferred embodiment of the present invention, as taken along line 3—3 of FIG. 2. FIG. 4 is similar to FIG. 3 except for the following: LED 108 is now mounted on the back of form 102 instead of on the front; and a pinhole 122 is in form 102 instead of in a mask 110. Pinhole 122 works similarly to pinhole 112 in FIG. 3, but the height 125 and width 123 of pinhole 122 may or may not be the same as height 115 and width 113, respectively, of pinhole 112. In FIG. 4, height 125 coincides with the thickness of form 102. However, if LED 108 is recessed in or raised above form 102, height 125 would differ from the thickness of form 102. Like pinhole 112 in FIG. 3, the width 123 of pinhole 122 is less than its height 125, so that the divergence of beacon light 212 from pinhole 122 is limited.

Each beacon lens 204 faces its corresponding pinhole 112 at a distance 208 from pinhole 112, which distance 208 is equal to the focal length of beacon lens 204, so that beacon light 212 from pinhole 112 is collimated by beacon lens 204 into beacon beam 216. Each communication lens 206 is similarly placed facing its corresponding fiber 106 at a distance 210 from fiber 106, which distance 210 is equal to the focal length of communication lens 206, so that communication light 214 from fiber 106 is collimated by communication lens 206 into communication beam 218. Beacon beam 216 and communication beam 218 may or may not be parallel, depending on the configuration of their respective targets. Each beam forms a real image at its respective target.

While a 16-element array has been discussed herein, it is to be appreciated that the system described may be scalable to virtually any size array, such as a one hundred element array (10 by 10), or a ten thousand element array (100 by 100), for example. Alternatively, the array can be one-dimensional or three-dimensional.

Although a collimated light beacon has been described in conjunction with the present invention, it is to be appreciated that no limitation on the present invention is intended. Rather, the present invention may be used with virtually any light source, including but not limited to collimated, converging, or diverging light sources.

While the methods and apparatus for the Optical Beacon for Aligning Mirror Systems of the present invention as herein shown and disclosed in detail is fully capable of obtaining the objects and providing the advantages herein before stated, it is to be understood that it is merely illustrative of preferred embodiments of the invention and that no limitations are intended to the details of the method, construction or design herein shown other than as described in the appended claims.

I claim:

1. An optical beacon for aligning optical elements, comprising:
a rigid body comprising at least one connection point, whereby at least one of said optical elements can be rigidly connected to said body;
at least one light source rigidly connected to said body, wherein said light source is located a known distance in a known direction from said at least one connection point;
switching means for switching said at least one light source independently of any other said at least one light source; and
at least one aperture, wherein light from said at least one light source passes through said aperture to space outside said body, whereby the divergence of said light is limited.

2. The optical beacon of claim 1, wherein said body further comprises said at least one aperture.

3. The optical beacon of claim 1, further comprising at least one mask comprising said at least one aperture.

4. The optical beacon of claim 3, wherein said at least one mask is rigidly connected to said body.

5. The optical beacon of claim 3, wherein said at least one mask is rigidly connected to said at least one light source.

6. The optical beacon of claim 1, wherein said distance is within one meter (1 m).

7. The optical beacon of claim 1, wherein said distance is within one hundred millimeters (100 mm).

8. The optical beacon of claim 1, wherein said distance is within ten millimeters (10 mm).

9. The optical beacon of claim 1, wherein said distance is within two millimeters (2 mm).

10. The optical beacon of claim 1, wherein said a t least one light source comprises a light-emitting diode.

11. The optical beacon of claim 1, wherein said switching means further comprises:
at least one common conductive path, and
at least one unique conductive path;
wherein said at least one light source further comprises two (2) terminals, wherein one of said terminals is electrically connected to said at least one common conductive path, and the other of said terminals is electrically connected uniquely to said at least one unique conductive path.

12. The optical beacon of claim 1, wherein said body further comprises at least part of said switching means.

13. The optical beacon of claim 12, wherein said at least part of said switching means comprises at least one conductive trace.

14. The optical beacon of claim 1, wherein at least part of said switching means comprises wire.

15. The optical beacon of claim 1, wherein said body comprises ceramic.

16. The optical beacon of claim 1, wherein the linear axial dimension of said at least one aperture is greater than its greatest linear dimension perpendicular to its axis.

17. The optical beacon of claim 1, wherein said at least one aperture comprises at least one linear edge.

18. The optical beacon of claim 1, wherein said at least one aperture comprises at least one curved edge.

19. The optical beacon of claim 1, wherein said at least one connection point comprises a two-dimensional array of at least two connection points by at least two connection points.

20. A method of generating an optical beacon signal for aligning of optical elements, comprising the steps of:
activating at least one light source rigidly connected to a rigid body, wherein said at least one light source is located a known distance in a known direction from at least one of said optical elements rigidly connected to said rigid body, wherein said activating is done independently of any other said at least one light source; and
limiting the divergence of light from said at least one light source.

21. The method of generating an optical beacon signal of claim 20, wherein said limiting of divergence is done by at least one aperture comprised by said body.

22. The method of generating an optical beacon signal of claim 20, wherein said limiting of divergence is done by at least one aperture comprised by an at least one mask rigidly connected to said body.

23. The method of generating an optical beacon signal of claim 20, wherein said limiting of divergence is done by at least one aperture comprised by an at least one mask rigidly connected to said light source.

24. The method of generating an optical beacon signal of claim 20, wherein said distance is within one meter (1 m).

25. The method of generating an optical beacon signal of claim 20, wherein said distance is within one hundred millimeters (100 mm).

26. The method of generating an optical beacon signal of claim 20, wherein said distance is within ten millimeters (10 mm).

27. The method of generating an optical beacon signal of claim 20, wherein said distance is within two millimeters (2 mm).

28. The method of generating an optical beacon signal of claim 20, wherein said at least one light source comprises a light-emitting diode.

29. The method of generating an optical beacon signal of claim 20, wherein said body comprises ceramic.
